(19) United States
(12) Patent Application Publication
(10) Pub. No.: US 2004/0195448 A1
(43) Pub. Date: Oct. 7, 2004

(54) Environmental control system

(76) Inventor: Richard J. Flatman, Derby (GB)

Correspondence Address: MANELLI DENISON & SELTER, 2000 M STREET NW SUITE 700, WASHINGTON, DC, 20036-3307, US

(21) Appl. No.: 10/724,094

(22) Filed: Dec. 1, 2003

(30) Foreign Application Priority Data
Dec. 14, 2002 (GB) 0229157.3

(51) Int. Cl. B64D 11/00

(52) U.S. Cl. 244/118.5

(57) ABSTRACT

An environmental control system for e.g. an aircraft cabin comprises ambient air pressurising compressor (16), air cooling device (30), an Air expanding turbine (26), all mounted for rotation on a common shaft (20). A main engine driven electric motor (16) provides the rotary power. An extra expansion turbine (26) is provided on shaft (20) and is connected to receive ejected, used air from cabin (18) and be driven thereby. The rotary force derived from turbine (26) is transferred via shaft (20) to the electric motor (16), thus reducing the power which otherwise would be needed from the aircraft main power plant.

The present invention relates to a system with which to control the atmosphere breathed by people in the confines of the cabin of a vehicle. The invention has particular efficacy, but not necessarily restrictively, when used in a passenger aircraft.

It is known, for example in published patent specification U.S. Pat. No. 6,216,981, to compress ambient air so as to heat it, then expand the heated air through a turbine so as to maintain some of the achieved pressure, and lower the achieved temperature. The still warm air is then passed through a mixing valve and water separating device prior to being passed to the passenger cabin of an associated aircraft. The breathed air is then dumped overboard.

In the publication, the compressors and turbines are driven by individual motors, which receive electricity from individual generators, which in turn are powered via connections to the main propulsion engines of the aircraft.

The known arrangement as described hereinbefore has a drawback, in that when the aircraft is at cruise altitude, that is when maximum pressurisation of the cabin is needed. Consequently, the main engines must divert more energy to the generators so as to enable the associated motors to rotate the compressors of the environmental control system at a greater speed. Main engine efficiency is thus reduced.

The present invention seeks to provide an improved environmental control system for use at least in passenger carrying aircraft.

According to the present invention an environmental control system comprises rotary air compression means, first and further rotary air expansion means and common rotary electrical drive means connected to drive them via a single shaft, wherein said air compression means and said first rotary air expansion means are connectable in flow series to an enclosed space volume for the purpose of pressurising it, and said further rotary air expansion means is connectable to said enclosed space volume for the purpose of receiving said pressurised air therefrom, so as to be rotatably driven thereby in order to provide at least some of the power needed to rotate said common electrical drive means via said single shaft.

The invention will now be described, by way of example and with reference to the accompanying drawings in which:

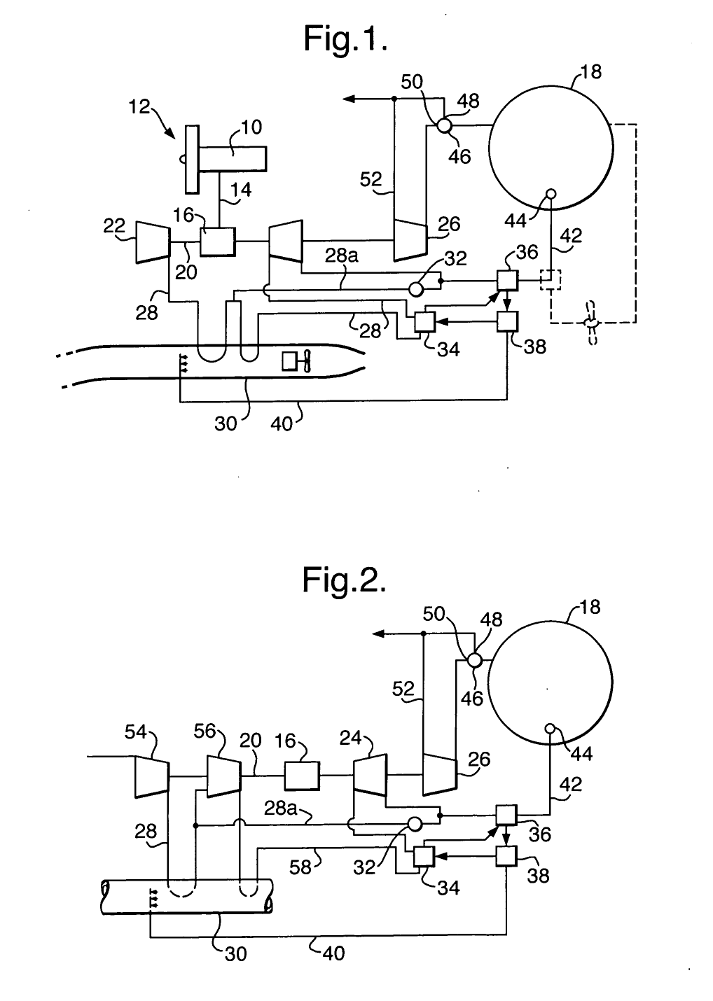

FIG. 1 is a diagrammatic sketch of an environmental control system in accordance with one aspect of the present invention, and

FIG. 2 is a diagrammatic part sketch of a further embodiment of an alternative environmental control system in accordance with the present invention.

The gas generator 10 of a ducted fan gas turbine engine 12 includes an electrical generator (not shown) which in turn is connected by a cable 14 to an electric motor 16 for the purpose of driving it during flight of an associated aircraft, only a cross sectional view of the cabin 18 of which is shown.

A single shaft 20 connects motor 16 to a compressor 22, a first expansion turbine 24, and a further expansion turbine 26. During operation of ducted fan gas turbine engine 12, electric motor 16 rotates shaft 20 and causes compressor 22 to receive and compress ambient air. The pressure to which the air is raised, is that needed to achieve appropriate pressurising of the aircraft cabin 18, having regard to the altitude at which the aircraft is flying. The air, heated during compression, passes via conduit 28 which enters and leaves a cooling, ram air flow tube 30, and then divides to provide a further conduit 28a, which extends to a temperature control valve 32. Conduit 28 however, again enters and leaves ram air tube 30, to pass to and through a heat exchanger 34 associated with a condenser 36 and water separator apparatus 38. On leaving heat exchanger 34, conduit 28 connects the compressed air flow to the input side of turbine 24. Expansion of the air as it passes through turbine 24 reduces its temperature, and on exit therefrom, it joins cooled air that has passed through temperature control valve 32, to flow therewith into condenser 36. Any water in the joined flow is separated and passed via conduit 40 to ram air duct 30, at a position upstream of conduit 28, so as to enable spraying of conduit 28 to achieve further cooling of the air flowing through it.

The now conditioned joined air, on leaving the condensing apparatus, passes via conduit 42, to a manifold 44 in the aircraft cabin 18, from whence it flows into the cabin interior in known, controlled manner. At this point, it is the norm to simply dump the used air overboard through valves in the cabin structure. However, in the structure described and illustrated in this specification, a valve 46 is provided between the cabin 18, and the further turbine 26, which valve has two selectable outlets 48 and 50. Outlet 48 enables dumping of the used air overboard in known manner. Outlet 50 enables direction of the used air into and through further turbine 26 so as to rotate it, and thereby contribute drive power to motor 16, thus reducing the working load on the core gas generator 10. In the latter case, the used air can be dumped via conduit 52 after exiting the further turbine 26. Alternatively, the used air can be re-introduced into the control system at some point of suitable pressure (not shown) and re-conditioned.

The used air will be caused to flow through turbine 26 so as to impart drive to electric motor 16, when the associated aircraft is flying at cruise altitude, which, as is known, is that period in the aircraft flight regime when maximum cabin pressurisation is needed. Thus, as the aircraft climbs to that altitude, valve 46 will be progressively manipulated by any appropriate means (not shown) so as to stop dumping air and start directing it to turbine 26. Maximum pressurising thus coincides with maximum boost drive to motor 16. When the aircraft loses altitude on approaching its destination, the procedure is reversed.

Valve 46 is only diagrammatically represented. It could be electrically actuated, or pneumatically actuated by the changing air pressure in the pressurisation system.

It is vital that the conditioned air has been reduced to an acceptable temperature when it reaches the interior of cabin 18. The heat is generated in the air flow through the system at its input end when ambient air is compressed by compressor 22, hence the need for heat exchanger apparatus. The greater the number of stages of blades in the compressor 22, the larger the heat exchange apparatus must be to achieve the necessary cooling. Therefor an alternative embodiment of the present invention is illustrated in FIG. 2, to which reference is now made.

In FIG. 2 in which parts corresponding to parts in FIG. 1 are given like numbers, the system utilises two compressors 54 and 56 on shaft 20. Each compressor 54 and 56 has fewer stages of blades than compressor 22 (FIG. 1) Compressor 54 receives ambient air and compresses it, then emits it at a lower temperature and pressure than that achieved by compressor 22 (FIG. 1). The emitted air is ducted via line 28 into and out of ram air tube 30. The now cooled air then divides, one part entering second compressor 56 and the other part passing via line 28a to temperature control valve 32. The output from compressor 56, again at a lower temperature and pressure than air leaving compressor 22 (FIG. 1)1 via ram air tube 30 and heat exchanger 34, passes to expansion turbine 24, the resulting expansion cooling it further. Thereafter, it meets air from temperature control valve 32 and the resulting mixed flow passes to the cabin 18 via the water separator 36 as described hereinbefore, with respect to FIG. 1.

The example of the present invention described with respect to FIG. 1 provides power from pressurised air that hitherto would be dumped to atmosphere, to supplement the power supplied to the electric drive motor normally driven only by an associated aircraft main engine.

The example of the present invention described with respect to FIG. 2 provides lower temperature air from a pair of compressors prior to the cooling step, thus enabling a reduction in size and weight of the cooling system.

I claim:

1. An environmental control system comprising rotary, ambient air compression means, first and further rotary air expansion means, and common rotary electrical drive means connected to drive them via a single shaft, wherein said rotary air compression means and said first rotary air expansion means are connectable in flow series to an enclosed space volume for the purpose of pressurising it, and said further rotary air expansion means is connectable to said enclosed space volume for the purpose of receiving said pressurised air therefrom so as to be rotatably driven thereby, in order to provide at least some of the power needed to rotate said common electrical drive means via said single shaft.

2. An environmental control system as claimed in claim 1 wherein a multi directional valve is positioned between said further rotary air expansion means and said enclosed space volume, so as to enable selective airflow therefrom to said rotary air expansion means or to atmosphere.

3. An environmental control system as claimed in claim 1 wherein said compression means consists of a single compressor that compresses ambient air and passes it through cooling structure then in part to said first air expansion means and in part to and through a temperature control valve, the expanded, cooled air from said expansion means thereafter joining and mixing with air in an outlet conduit from said temperature control valve.

4. An environmental control system as claimed in claim 1 wherein said compression means comprises two compressors, one of which compresses ambient air and passes it through cooling structure, then in part to the other compressor and in part to and through a temperature control valve.

5. An environmental control system as claimed in claim 4 wherein said other compressor further compresses said ambient air from said one compressor and, via said cooling means, delivers it to said first air expansion means which then delivers the expanded, and thereby further cooled air, to an output conduit from and downstream of said temperature control valve, to mix with said air from said one compressor.

6. An environmental control system as claimed in claim 1 wherein all said air expansion means are turbine structures.

7. An environmental control system as claimed in claim 3 wherein said mixed air in said outlet conduit from said temperature control valve passes via water separation apparatus into said enclosed space volume, and is then ejected to atmosphere or to said further expansion means.

8. An environmental control system as claimed in claim 1 wherein the enclosed space volume comprises the cabin of an aircraft.
